(19) United States
(12) Patent Application Publication
(10) Pub. No.: US 2025/0100932 A1
(43) Pub. Date: Mar. 27, 2025

(54) CHEMICAL ACTIVATION OF SUPERCALCINED CLAYS

(71) Applicant: CEMENTOS ARGOS S.A., Medellín (CO)

(72) Inventor: María Fernanda DÍAZ BURBANO, Medellín (CO)

(21) Appl. No.: 18/891,436

(22) Filed: Sep. 20, 2024

Related U.S. Application Data
(60) Provisional application No. 63/584,231, filed on Sep. 21, 2023.

(51) Int. Cl. C04B 28/00; C04B 22/06; C04B 28/26; C04B 40/00

(52) U.S. Cl. CPC C04B 28/006; C04B 22/062; C04B 28/26; C04B 40/0082

(57) ABSTRACT

An improved supplementary cementitious material (SCS) comprising previously supercalcined clays (calcined at temperatures between 90° and 1500° C.) and a chemical activator selected from a silicate, a strong base or a mixture of activators comprising a mixture of silicate-strong base.

### CROSS-REFERENCE OF RELATED APPLICATIONS

The present application claims priority from U.S. Provisional Application Ser. No. 63/584,231 filed on Sep. 21, 2023, which is incorporated herein in its entirety.

### FIELD OF THE INVENTION

The present invention is in the field of construction industry materials. Particularly, supplementary cementitious materials (SCM) based on calcined clay products, produced at relative high calcination temperature defined as over-calcination (supercalcined clay). The clays tested covers from low and medium-quality materials.

### BACKGROUND

Supplementary cementitious materials (SCM) have been described in papers and patents throughout history. SCMs are inorganic materials compounds mainly by alumina and silica that contribute to the properties of hardened cementitious materials through hydraulic activity, pozzolanic activity, or both. Typically, SCMs replace part of Portland cement that is in the main component of a concrete mixture, those SCMs are generally byproducts of other industries, or natural materials, such as natural pozzolans, metakaolin, or calcined clay. Currently, there is a high demand for clays suitable of activation to be included as SCM in cements.

For example, the construction material composition disclosed in U.S. Pat. No. 10,544,060 comprises a matrix predominantly containing an aluminosilicate compound, preferably metakaolin, and an alkaline activating solution. Said matrix has a “fast” metakaolin (“flashed” metakaolin) produced by calcining powdered clay at a temperature between 600 and 900° C. for a few seconds, followed by rapid cooling. On the other hand, the alkaline activating solution comprises a sodium or potassium silicate source and an alkaline base, such as NaOH and/or KOH.

On the other hand, U.S. Pat. No. 4,642,137 describes a binder composition for use in conjunction with Portland cement comprising 100 parts metakaolin (produced by dehydroxylation of kaolinite by heating to 500° C., preferably between 600° C. and 800° C.), 20 to 70 parts of slag, 85 to 130 parts of at least one material selected from fly ash, calcined shale, and calcined clay; 70 to 215 parts of finely divided silica, 50 to 145 parts of at least one material selected from potassium silicate and potassium hydroxide, wherein there are at least 55 parts of potassium silicate.

The previously described solutions include metakaolin as a starting material. Metakaolin is a mineral rich in kaolinite (above 60% of kaolinite content in raw clay approximately) previously subjected to thermal activation. However, there is still a need for developing SCMs using clays having different pozzolanic activity potential but that were previously calcined at temperatures above 900° C. (i.e., super-calcined clays), looking to reduce the water demand that calcined clays produced in concrete and that affect concrete performance, that SCMs over calcined can reach the desired properties without affecting its physical characteristics such as high initial strength at 2 days greater than 45 MPa, greater durability when cement or concrete is designed with this material and, rapid hydration, compared to traditional SCMs. Developing this type of material is interesting, among other reasons, because there is a more favorable cost-benefit ratio by using clays with less demand in the market compared with pure kaolin source, moreover natural resources with the greatest demand are not exhausted, helping in confronting the over-exploitation of natural resources.

### SUMMARY OF THE INVENTION

The technical development described herein corresponds to a supplementary cementitious material (SCM) comprising a clay previously calcined at high temperatures (over 900° C.) and a chemical activator selected between a silicate, a strong base, or a mixture thereof.

### BRIEF DESCRIPTION OF THE DRAWINGS

FIG. 1 Chemical activation with a strong base (NaOH) at different molarities (4M, 6M, 8M, 10M, and 12M) of medium content of kaolinite clays at super calcined conditions between 1000-1200° C. Compressive strength of 7 d pastes (MPa).

FIG. 2 Chemical activation with a mix of strong base (NaOH) and silicate (Na₂SiO₃) at different molarities (8M, 10M, and 12M) and concentrations, of medium content of kaolinite clays at supercalcined conditions between 1000-1200° C. Compressive strength of 7 d pastes (MPa).

FIG. 3 Chemical activation with a strong base (NaOH) at different molarities (4M, 6M, 10M and 12M), mixtures of strong base and silicate (NaOH and Na₂SiO₃) of low, medium, and rich content of kaolinite clays at supercalcined conditions between 1000-1200° C. Compressive strength of 7 d pastes (MPa).

### DETAILED DESCRIPTION

Terms used in the following description have the meanings normally given to them in the technical field unless this description or the context clearly indicates otherwise. Where appropriate, terms used in the singular form shall also include the plural form. Unless otherwise indicated, by either contextual implications or customary practices, all parts and percentages in the present description are based on weight. The term “approximately” means variations of +5% of the defined value.

The present development corresponds to an improved supplementary cementitious material (SCM) comprising previously super calcined clays activated by chemical activators. The chemical activators would vary depending on the quality of the clay and are selected from a silicate, a strong base, or a mixture thereof.

### Supplementary Cementitious Material (SCM)

Supplementary cementitious materials (SCM) are used to reduce the clinker amount in cementitious materials. In general, the term cementitious material is defined as that material capable, in some cases by itself or in combination with other cementitious materials, of forming hydration products such as calcium silicate hydrates (C-S-H), aluminosilicate hydrates (A-S-H) or calcium aluminosilicate hydrates (C-A-S-H). Cementitious material includes Portland cement, fly ash, natural or artificial pozzolans, silica fume, and granulated blast furnace slag (GGBFS).

The use of the term supplementary refers to the function of supplementing or complementing the properties that these materials have in relation to cement since they can enhance said properties or, in certain cases, make up for some of its deficiencies to comply with the specifications of a project.

Due to the nature of raw clays, different types of compositions and colors can be found, each with different levels of purity and variable mineral content that may be presumed unfavorable for use in building materials such as SCM. This is the case of those raw clays with low/poor or medium/moderate levels of kaolinite compared with the requirements for ceramic or paint industry for example, since it is the main mineral for which clay is still widely used.

Raw clays can have a mixture of several minerals with different characteristics or pure clay with only one mineral. Raw clays (without being subjected to a thermal activation process) comprise one or more of the following clay minerals: gibbsite, goethite, montmorillonite, kaolinite, chlorites, micas, muscovites, halloysite, metahalloysite, and quartz or mixtures thereof. However, raw clays have complex mineralogy, due to the presence of clay minerals such as kaolinite, montmorillonite, halloysite, and illite.

The clays used in this development correspond to previously calcined clays, however, when talking about their kaolin content it is in the raw clay. Preferably, the calcined clays used in the present invention should have amorphous Silica (Si) and Alumina (Al), or at least 40% reactive Si. The kaolinite content, the reactivity, and the presence of a strong chemical activator promotes a synergy that cause the chemical elements to solubilize, the reaction (between silicates, aluminates, calcium, and water to form the CSH and CASH mentioned above) to occur, and the phases responsible for generating strength in the material to be formed.

### Kaolinite Content

In a preferred embodiment, the clay used in the supplementary cementitious material generally has no preference in thermal or chemical activation processes. Without the aim of compelling to a particular reason, it is possible that this is because the raw clays do not have the desired amounts of kaolinite (higher than 60%), and on the contrary, it has low or medium amounts of kaolinite (below 60%). The above values are by weight of the crystalline phases of the clay.

Kaolinite is a clay mineral, with the chemical composition Al₂Si₂O₅ (OH)₄. However, the amount of kaolinite in each clay may vary. Therefore, clays can be divided into three broad categories, rich kaolinite clay content, medium kaolinite clay content, and low kaolinite clay content. According to our experience in clays and using X-ray diffraction (XRD) analysis, we define the type of clays as a rich kaolinite clay corresponds to those clays with kaolinite content above 60%, a medium kaolinite clay corresponds to those clays with kaolinite content between 40% and 60%, preferably between 40% and 55%, finally, the low kaolinite clay corresponds to those clay with kaolinite content below 40% kaolinite, preferably between 10 and 40% kaolinite.

Even though the present development can include rich kaolinite content clays, in a preferred embodiment, SCMs include medium and low kaolinite clays with a maximum of 60% kaolinite.

Without the aim of compelling to a particular reason, activation results of low kaolinite clays are not predictable due to their low kaolinite content and the presence of clay minerals such as montmorillonite, halloysite, and illite, as well as low amorphous, reactive Silica and Alumina reactivity, which may favor activation. In addition, these characteristics may vary depending on the geological formation and the heat treatment to which clays are subjected.

### Calcination

Usually, raw clays must be calcined between 60° and 800° C. to achieve the formation of amorphous/reactive phases. Theoretically, at higher temperatures, the formation of crystalline, hard, and not very reactive phases such as spinel type and/or mullite are favored. However, as concluded in the instant development, different types of clays calcined at higher temperatures than typically recommended (between 60° and 800° C.), are greatly improved by chemical or alkaline activation.

During the process for SCM, the clay is further thermally activated, particularly, clays are over-calcined or supercalcined at temperatures higher than 800° C., more particularly higher than 900° C. For the purposes of this description, the expressions “super calcined” and “over-calcined” are understood interchangeably. For the purposes of this description, clays calcined at higher temperatures than the typical temperatures are defined as super-calcined clays. Super-calcination temperatures as used in the instant SCM are above 800° C., above 900° C., between 800° C. and 1100° C., between 850° C. and 1100° C., preferably between 900° C. and 1100° C., between 100° and 1200° C., or between 1000° C. and 1100° C. Not to adhere to a specific scientific theory, perhaps the phases present at temperatures above 800° C. are compatible with the chemical activators, favoring the solubility of the chemical elements and therefore increasing the reaction to produce desired strengths.

Calcination of clays can be carried out using any of the most common techniques, such as: static, rotary or flash calcination. In the calcination process, three main phenomena can be distinguished: dehydration, dehydroxylation, and recrystallization. These stages take place at different temperatures depending on the characteristics of the material and the process conditions.

Static: When large quantities of clay are calcined using static calcination, such as in muffle furnaces, a highly non-uniform temperature distribution in the clay can result. While parts of the clay can be heated to temperatures as high as 1100° C., other parts may not even reach 500° C., despite several days of soaking; however, this will depend on the size and filling of the furnace. For this reason, static calcination is suitable only for small quantities of clay, mainly for laboratory use.

Rotary: In rotary kiln calcination, the clay must be crushed to the size of a few centimeters and relatively uniform calcination can be achieved with a residence time of less than 1 h. Temperature control in the rotary kiln is also non-trivial and can affect the quality of the clay and depending on the residence time, can cause agglomeration and generate lumps.

Flash: On the other hand, in flash calcination, gas-solid heat transfer is exploited to calcine the material rapidly. Flash calcination requires pretreatment of the ground raw clay to a dry, fine powder prior to calcination, allowing it to be a pneumatically suspended feed within a carrier gas.

### Chemical Activation

Chemical activation is a technology focused on potentiating or activating supplementary cementitious materials such as blast furnace slag and fly ash, to increase their participation in cement and concrete recipes. However, natural pozzolans are even more abundant and available resources but, as mentioned above, chemical activation of these materials has been challenging due to their complex mineralogy, such as the presence of clay minerals such as kaolinite, montmorillonite, halloysite, and illite, which can absorb water and affect the mechanical performance and workability of the cement and resulting concrete. On the other hand, the amorphous content is also a limitation.

Therefore, contrary to expectations, the present development successfully activates super-calcined clays by chemical activation with a chemical activator, resulting in an SCM having excellent properties.

A chemical activator is a substance that facilitates the initiation of the chemical reaction between aluminosilicates and water. This reaction allows SCM to improve or enhance the properties of cementitious mixtures, such as hydroxides of alkali metals and alkaline earth metals. For the present development, the chemical activator is selected between a silicate, a strong base, or a mixture thereof. The silicates are selected from, but are not limited to alkaline silicates, quartz (SiO₂), sodium silicate (Na₂SiO₃), potassium silicate (K₂SiO₃), lithium silicate (Li₂SiO₃), magnesium silicate (MgSiO₃), calcium silicate (CaSiO₃), aluminum silicate (Al₂SiO₅), zinc silicate (Zn₂SiO₄), and barium silicate (BaSiO₃), among others. The strong base is selected from, but is not limited to sodium hydroxide (NaOH), potassium hydroxide (KOH), lithium hydroxide (LiOH), rubidium hydroxide (RbOH), cesium hydroxide (CsOH), calcium hydroxide (Ca(OH)₂), barium hydroxide (Ba(OH)₂), strontium hydroxide (Sr(OH)₂), sodium methoxide (CH₃ONa), potassium methoxide (CH₃OK), sodium methoxide (NaOMe), lithium diisopropylamide (LDA), and potassium amide (KNH₂), among others. Preferably, the strong bases are selected from NaOH, KOH, CaOH, and the silicates are alkaline silicates selected from sodium silicate (Na₂SiO₃), calcium silicate (Ca₂O₄Si), magnesium silicate (MgSiO₃) or potassium silicate K₄(SiO₄). The molarity of the chemical activator is between 8 and 12M. In one embodiment, the chemical activator is a mixture of at least one silicate and at least one strong base, preferably NaOH and Na₂SiO₃.

In another embodiment, the silicate-strong base ratio is between 60:40 and 90:10 (silicate:strong base). While activator mix ratios outside of this range might activate the clay, they would not activate as much as in the preferred range.

### Liquid Solid Ratio

One of the parameters that the inventors found useful to finally activate the super calcined clays is a ratio between the chemical activator and the super calcined clay. This means that the amount of chemical activator depends on the amount of super calcined clay. In one embodiment, the chemical activator is in liquid form while the super calcined clay is in solid form. Thus, the liquid/solid (L/S) ratio is between 0.2 and 0.6, or between 0.2 and 0.5, between 0.3 to 0.5, between 0.4 to 0.6, or between 0.4 to 0.5. If the L/S ratio is below 0.2, the results are not good, they do not generate compressive strength and if it is above 0.6, perhaps they are expensive formulations or they may also affect the compressive strength. In another embodiment, the chemical activator is in solid form as the super calcined clay. Thus, the percentage of the chemical activator in the mixture is between 1 to 15%.

Preferably, when the supercalcined clay is a poor clay, that is with a kaolinite content below 40%, below 35%, or between 20% and 30%, the chemical activator is a strong base. Preferably, when the supercalcined is medium kaolinite clay, that is with a kaolinite content higher than 35%, higher than 40%, or between 35 and 50%, the chemical activator is a mixture of a silicate and a strong base.

The present development will be presented in detail through the following examples, which are provided for illustrative purposes only and are not intended to limit its scope.

### Uses

The present development is directed to a pozzolanic mixture useful as supplementary cementitious material (SCM), for example, in the formulation of a cementitious composition and in the formulation of mortars, pastes, and concretes, among others. The SCM described herein may be formulated into a pozzolanic-type cement, blended, or composite cement, general use cement (GU), high early strength (HE), moderate/mild sulfate strength (MS), high sulfate strength (HS), moderate heat of hydration (MH), low heat of hydration (LH), structural cement, concrete cement, soil cement, and masonry. For example, different HE, GU, MS, and MH cements may be proportioned in accordance with ASTM C1157.

### Method for Preparing a SCM

Method for the preparation of a supplementary cementitious material which comprises mixing previously calcined clay with a chemical activator; wherein the previously calcined clay is over-calcined above 900° C. and below 1500° C., and wherein the chemical activator is selected from a silicate, a strong base, or a mixture thereof. The chemical activator (liquid) and the previously over-calcined clay (solid) are mixed at a liquid/solid (L/S) ratio between 0.2 and 0.6.

### Method for Utilizing the SCM to Produce Pastes

The method here described comprises the following steps:
Preparing a mixture of previously over-calcined clay and a chemical activator according to the development already described;
Mixing cementitious composition components, water, and admixtures (if necessary, depending on the desired performance properties) with the previously over-calcined clay and chemical activator mix of the invention to obtain a uniform paste.

Unlike mortar, sand is not included in the mixture to produce a paste. The cementitious composition components include, but are not limited to clinker, at least one setting regulator, a cement additive, and an inert filler such as limestone.

In another embodiment, the method for utilizing the SCM to produce pastes comprises mixing a previously over-calcined clay, a chemical activator, cementitious composition components, water, and admixtures (if necessary) in a single step.

### Method for Utilizing the SCM to Produce Mortars

The method here described comprises the following steps:
Preparing a mixture of previously over-calcined clay and a chemical activator according to the development already described;
Mixing cementitious composition components, sand, water, and admixtures (if necessary, depending on the desired performance properties), with the previously over-calcined clay and chemical activator mix of the invention until a homogeneous mortar is obtained.

The cementitious composition components include, but are not limited to, clinker, at least one setting regulator, a cement additive, and an inert filler such as limestone.

In another embodiment, the method for utilizing the SCM to produce mortars comprises mixing a previously over-calcined clay, a chemical activator, cementitious composition components, sands, water and admixtures (if necessary) in a single step.

### Method for Utilizing the SCM to Produce Concrete

The method here described comprises the following steps:
Preparing a mixture of previously over-calcined clay and a chemical activator according to the development already described;
Mixing cementitious composition components, fine aggregates, coarse aggregates, water, and chemical admixtures (such as superplasticizers, as needed) with the previously over-calcined clay and chemical activator mix until homogeneously blended, to achieve the desired concrete consistency and workability.

The cementitious composition components include, but are not limited to, clinker, at least one setting regulator, a cement additive, and an inert filler such as limestone.

In another embodiment, the method for utilizing the SCM to produce concrete comprises mixing a previously over-calcined clay, a chemical activator, cementitious composition components, fine aggregates, coarse aggregates, water, and chemical admixtures (if necessary) in a single step.

### EXAMPLES

### Example 1. Characterization of Raw Clays

Raw clay (clays that have not been subjected to calcination) samples were subjected to chemical analysis. Clays with high Si, Al, and Fe contents and low Loss of Ignition (LOI) value are sought, and preferably with reactive Si and Al with XFR, however, it does not necessarily mean that Si and Al are reactive and to find out that we go on to other tests, such as XRD.

TABLE 1
Chemical analysis of rich, medium, and low kaolinite
clays without calcination (XRF)

| | Rich | Medium | Low kaolinite |
|---|---|---|---|
| | kaolinite | kaolinite raw | raw |
| | raw clay | clay | clay |
| LOI | 16.21 | 9.65 | 7.93 |
| SiO₂ | 42.77 | 53.41 | 60.66 |
| Al₂O₃ | 37.42 | 23.42 | 19.02 |
| Fe2O₃ | 1.11 | 9.91 | 8.14 |
| Si + Al + Fe | 81.30 | 86.74 | 87.82 |

LOI = Loss of Ignition

TABLE 2
X-Ray Diffraction (XRD) raw clays

| | Rich kaolinite | Medium kaolinite | Low kaolinite |
|---|---|---|---|
| | raw clay | raw clay | raw clay |
| Quartz low | 5% | 35% | 64% |
| Hematite | 1% | 0% | 0% |
| Kaolinite | 63% | 45% | 19% |
| Muscovite | 0% | 17% | 31% |
| Anatase | 3% | 0% | 0% |
| Gibbsite | 11% | 3% | 5% |
| Dickite | 17% | 0% | 0% |

TABLE 3
Reactive Si in raw clays

| Name Sample | % reactive SiO₂ |
|---|---|
| Rich kaolinite clay without calcining | 42.57 |
| Low kaolinite clay without calcining | 41.63 |

The previous analyses are carried out to know the quality of the raw materials, through their chemistry, mineralogy, and reactivity of phases such as silica, which generate a starting point to potentiate the material using thermal and chemical activation. From the previous tables it can be concluded that although the chemical analysis shows high levels of Si and Al, it is necessary to know how Si and Al are found, if it is in a crystalline phase it would not be expected to be very reactive, but if Si and Al are in the amorphous or reactive phase, it is a condition to achieve a greater activation of the material.

### Example 2. Characterization of Calcined Clays

The clays described in Example 1 were subjected to calcination, particularly between 100° and 1200° C., below is the chemical characterization of those clays.

TABLE 4
Chemical characterization of supercalcined clays

| | Rich kaolinite | Medium kaolinite | Low kaolinite |
|---|---|---|---|
| LOI | 0.95 | 0.83 | 0.49 |
| SiO₂ | 50.63 | 57.31 | 65.08 |
| TiO₂ | 2.24 | 0.98 | 1.22 |
| Al₂O₃ | 44.05 | 26.21 | 20.58 |
| Fe₂O₃ | 1.38 | 12.3 | 9.16 |
| Mn₃O₄ | 0 | 0.02 | 0.07 |
| MgO | 0.09 | 0.4 | 0.48 |
| CaO | 0.06 | 0.1 | 0.2 |
| Na₂O | 0.22 | 0.33 | 0.29 |
| K₂O | 0.06 | 1.18 | 2.08 |
| P₂O₅ | 0.08 | 0.14 | 0.1 |
| SO₃ | 0.01 | 0.01 | 0.04 |
| Si + Al + Fe | 96.06 | 95.82 | 94.82 |

When a raw clay is subjected to a temperature ramp, it experiences weight loss associated with the evaporation of water that occurs around 100° C., followed by 400° C. where the dehydroxylation process takes place, i.e., the hydroxyl (OH) bonds present in the kaolinite mineral are broken and a destabilization of the system is formed. In addition, decarbonation of carbonates minerals that may be present such as CaCO₃ or MgCO₃ take place between 600-900° C.

After, a XRD analysis was made to identify the mineralogical phases of the clays and determine the crystalline structure and composition of the material, and even, from the XRD, the amorphous content can be inferred, a variable of great importance for alkaline activation.

TABLE 5
Amount of amorphous in XRD (X-ray diffraction)
analysis for supercalcined clays

| | Rich kaolinite at 1000-1200° C. |
|---|---|
| Quartz low | 2.6 |
| Kaolinite | — |
| Anatase | 1.7 |
| Aluminium oxide | 6.8 |
| Amorphous | 88.8 |
| | Medium kaolinite at 1000-1200° C. |
| Quartz low | 28.4 |
| Iron Aluminium | 0.9 |
| Dialuminium | 6.2 |
| Hematite | — |
| Kaolinite | — |
| Zeolite | — |
| Muscovite | — |
| Amorphous | 64.4 |
| | Low kaolinite at 1000-1200° C. |
| Quartz low | 45.9 |
| Hematite | 4.2 |
| Muscovite | — |
| Gibbsite | — |
| Sillimanite | 4.2 |
| Wuestite | 0.1 |
| Amorphous | 45.6 |

Finally, the following tables describe the effect of calcination temperature on the amorphous and reactive Si content of calcined clays. It is identified that the amorphous content tends to increase with the calcination temperature in the evaluated ranges. The amorphous content is a variable of great importance for alkaline activation because it is the phase that will react.

TABLE 6
Amount of amorphous depending on the calcination temperature

| Amorphous | Raw (without | | | |
|---|---|---|---|---|
| content | calcination) | 700° C. | 850° C. | 1000-1200° C. |
| Rich | 61.2% | 78.8% | 77.9% | 88.8% |
| Medium | 43.1% | 56.5% | 58.1% | 64.4% |
| Low | 41.6% | 16.6% | 35.1% | 45.6% |

TABLE 7
Reactive Si in supercalcined clays

| Name Sample | % reactive SiO₂ |
|---|---|
| Rich 1000-1200° C. | 48.75 |
| Medium 1000-1200° C. | 53.62 |
| Poor 1000-1200° C. | 51.63 |

An increase in reactive Si is identified in supercalcined clays vs. raw clays, that is, the high temperature may be destabilizing the system and leaving the silica in a reactive state that is required for chemical activation.

### Example 3. Alkaline Activation of Supercalcined Clays and Results Obtained

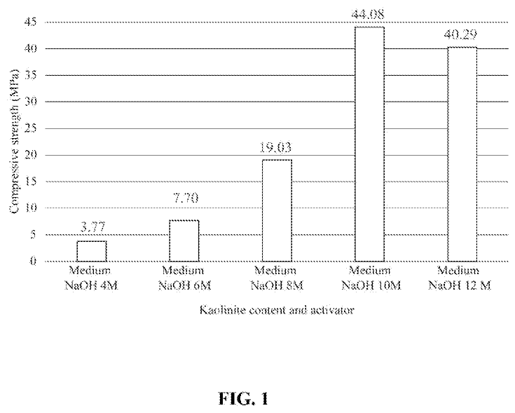

Previously calcined clay samples with medium kaolinite content, when they were in raw clay, were chemically activated with NaOH and supercalcined between 1000 and 1200° C., the compressive strength results are shown in FIG. 1. As an outstanding result, it can be seen in FIG. 1 that the clay that obtained the excellent activation results reaching compressive strength values above 40 MPa. This is particularly interesting given that clays without the proposed chemical activation usually show compressive strength between 2 and 3 MPa, wherein amounts above 10 MPa are already considered improved.

### Example 4. Chemical Activation of Supercalcined Clays and Results Obtained

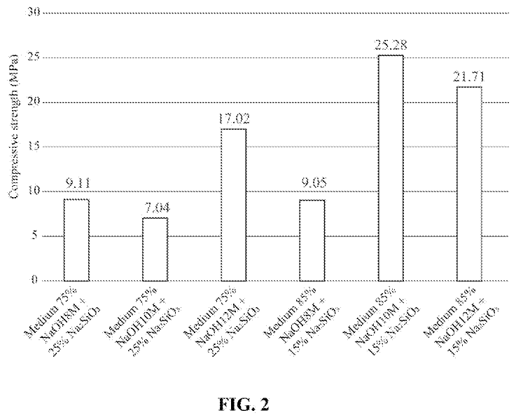

Mixtures of activators with the preferred results of NaOH obtained in Example 3, were mixed with Na₂SiO₃ in different amounts and concentrations. The results are shown in FIG. 2 which were dosed with an L/S ratio between 0.3 and 0.5 looking for appropriate hydration of the cementing material, in this case, the calcined clay. The proposed mixture of activators also activates the clays which is a valid activation option since they all gave better results than clays without activation, as described above.

### Example 5. Calcined Clay with Low, Medium, and Rich Kaolinite Content Chemically Activated in Supercalcined Conditions

Clay samples with low, medium, and rich kaolinite content (above 60%) were chemically activated with NaOH alone or in combination with Na₂SiO₃ at different concentrations, which was dosed with an L/S ratio between 0.3 and 0.5 seeking an adequate mix, hydration of the cementing material and dissolution of the phases, in this case, supercalcined clay. After the activation, they were calcinated at temperatures above 1000° C., more particularly between 100° and 1200° C.

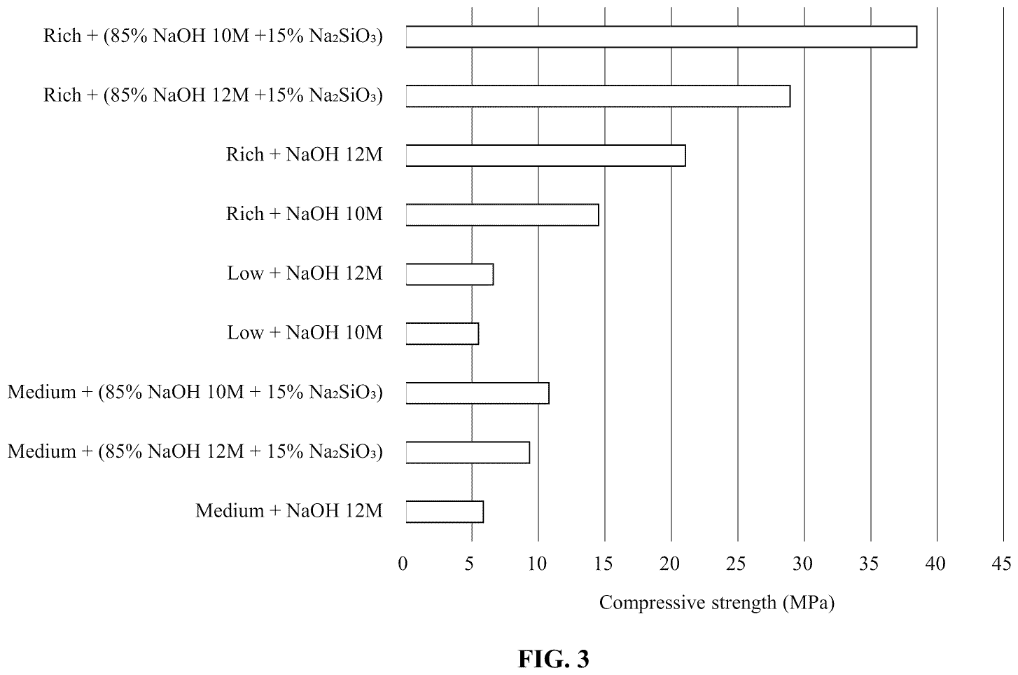

Once the homogenization of the SCM and the activator was achieved, the compressive strength of the chemically activated supercalcined low, medium, and rich clays were evaluated using paste cubes. These paste cubes had dimensions of 50 mm on each side. The detail of the procedure is adopted from the ASTM C 109 standard. The preparation of the paste cubes (SCM+activator+water) is carried out using bronze molds with a capacity of 3 cubes so that they are tested for 7 days, at which time the preparation can begin demonstrating the potential of the material. The results are shown in FIG. 3.

It is concluded that this activation was successful because the compressive strengths in supercalcined conditions were higher than the chemical activation of calcined clays at a conventional temperature which is usually between 2 and 3 MPa (not shown in the figure).

What is claimed is:

1. A Supplementary Cementitious Material (SCM) comprising:
previously calcined clay at temperatures above 900° C. and below 1500° C.; and
a chemical activator selected from a silicate, a strong base or a mixture thereof;
wherein the chemical activator (liquid) and the previously over-calcined clay (solid) have a liquid/solid (L/S) ratio between 0.2 and 0.6.

2. The SCM according to claim 1, wherein the previously calcined clay has medium kaolinite content in the raw clay.

3. The SCM according to claim 1, wherein the mixture of activators is at least one silicate and at least one strong base.

4. The SCM according to claim 3, wherein the silicate-strong base ratio is between 60:40 and 90:10 (silicate:strong base).

5. The SCM according to claim 1, wherein when the previously calcined clay has a kaolinite content below 35% in the raw clay and the activator is a strong base.

6. The SCM according to claim 5, wherein when the previously calcined clay has a kaolinite content between 20% and 30% in the raw clay and the activator is a strong base.

7. The SCM according to claim 1, wherein when the previously calcined clay has a kaolinite content higher than 35% in the raw clay and the activator is a mixture of activators.

8. The SCM according to claim 7, wherein when the previously calcined clay has a kaolinite content between 35% and 50% in the raw clay and the activator is a mixture of a silicate and a strong base.

9. A method for preparing a supplementary cementitious material comprising:
mixing a previously over-calcined clay at temperatures above 900° C. and below 1500° C. with a chemical activator selected from a silicate, a strong base or a mixture thereof;
wherein the chemical activator (liquid) and the previously over-calcined clay (solid) have a liquid/solid (L/S) ratio between 0.2 and 0.6.

10. A method for preparing a mortar comprising:
preparing a mixture of a previously over-calcined clay and a chemical activator; and
mixing it with cementitious composition components, sand, water, and optionally admixtures;
wherein the clay was previously over-calcined at temperatures above 900° C. and below 1500° C., the chemical activator is selected from a silicate, a strong base or a mixture thereof;
and wherein the chemical activator (liquid) and the previously over-calcined clay (solid) have a liquid/solid (L/S) ratio between 0.2 and 0.6.

11. A method for preparing concrete comprising:
preparing a mixture of a previously over-calcined clay and a chemical activator, and mixing it with cementitious composition components, fine aggregates, coarse aggregates, water, and chemical admixtures;
wherein the clay was previously over-calcined clay at temperatures above 900° C. and below 1500° C. with a chemical activator selected from a silicate, a strong base or a mixture thereof; wherein the chemical activator (liquid) and the previously over-calcined clay (solid) have a liquid/solid (L/S) ratio between 0.2 and 0.6.
